(19) United States
(12) Patent Application Publication
(10) Pub. No.: US 2022/0065038 A1
(43) Pub. Date: Mar. 3, 2022

(54) MOTORIZED WINDOW BLIND WITH TRANSMISSION DEIVCE IN BOTTOM RAIL

(71) Applicant: WEN YING LIANG, Changhua County (TW)

(72) Inventor: WEN YING LIANG, Changhua County (TW)

(21) Appl. No.: 17/039,743

(22) Filed: Sep. 30, 2020

(30) Foreign Application Priority Data
Sep. 3, 2020 (TW) 109211528

(51) Int. Cl. E06B 9/70; E06B 9/322

(52) U.S. Cl. CPC E06B 9/70; E06B 2009/6809; E06B 9/322

(57) ABSTRACT

A motorized window blind includes a top rail, a bottom rail, a plurality of slats assembled between the top rail and the bottom rail, and a driving device received in the bottom rail. The driving device includes a transmission unit, a motor, a first cord and a second cord. A first end of each of the first and second cords is connected to the transmission unit, and a second end of each of the first and second cords extends through the slats and is connected to the top rail. The motor is connected to and drives the transmission unit to lift and lower the slats. The driving device received in the bottom rail is easily maintained. The top rail does not occupy too much space and is easily to be installed.

### BACKGROUND OF THE INVENTION

### 1. Fields of the Invention

The present invention relates to a motorized window blind, and more particularly, to a window blind with its transmission device located in the bottom rail.

### 2. Descriptions of Related Art

The conventional motorized blinds generally include a driving device which controls the slats to be lifted or lowered. The driving device is usually located within the top rail of the blind. However, some rooms do not provide sufficient space for the top rail with the driving device therein. Besides, the driving device is heavy so that the top rail needs to be properly supported. When only a limited room can be used to install the motorized blind, the top rail with the driving device therein may not able to be installed. In addition, driving device located at the high position is not convenient for maintenance.

The present invention intends to provide a motorized window blind with its transmission device located in the bottom rail so as to eliminate shortcomings mentioned above.

### SUMMARY OF THE INVENTION

The present invention relates to a motorized window blind, and comprises a top rail, a bottom rail, a plurality of slats assembled between the top rail and the bottom rail, and a driving device received in the bottom rail. The driving device includes a transmission unit, a motor, a first cord and a second cord. The motor is connected to the transmission unit. A first end of each of the first and second cords is connected to the transmission unit, and a second end of each of the first and second cords extends through the slats and is connected to the top rail. The transmission unit is driven by the motor to lift and lower the slats.

Preferably, the driving device includes a power supply which is electrically connected to the motor.

Preferably, the power supply includes a chargeable battery and a battery box in which the chargeable battery is received.

Preferably, the driving device is electronically connected with a wireless controller.

Preferably, the transmission unit includes a passive member, a first member and a second member. The passive member, the first member and the second member are received in a box. The passive member includes a bevel gear and a main gear which is co-axially formed with the bevel gear. The motor includes a shaft which is connected with a driving gear. The driving gear is engaged with the bevel gear so as to drive the passive member. The main gear is located beneath the bevel gear. The first member includes at least one first gear and a first spool. The second member includes at least one second gear and a second spool. At least one first gear of the first member is engaged with the main gear of the passive member so as to rotate the first member in a rotational direction opposite to a rotational direction of the passive member. The first cord is wound to the first spool and extends through the slats, and is connected to the top rail. The second gear of the second member is engaged with the first gear of the first member. The first member rotates the second member to rotate in a rotational direction opposite to a rotational direction of the first member. The second cord is wound to the second spool and extends through the slats, and is connected to the top rail.

Preferably, the bottom rail includes a housing and a bottom plate. The driving device is received in the housing and the bottom plate is connected to the housing.

The primary object of the present invention is to provide a motorized window blind, wherein the driving device is received in the bottom rail so that it is easily maintained.

In addition, the top rail does not have the driving device received therein so that it is light and occupies less space and is easily to be installed.

The motorized window blind is able to be operated manually even if the electric power is not available.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the motorized window blind of the present invention;

FIG. 2 is an exploded view of the motorized window blind of the present invention;

FIG. 3 is a perspective view to show the transmission unit of the motorized window blind of the present invention;

FIG. 4 is an exploded view to show the transmission unit of the motorized window blind of the present invention;

FIG. 5 shows an operational status of the transmission unit of the motorized window blind of the present invention, and the blind is lowered;

FIG. 6 shows another operational status of the transmission unit of the motorized window blind of the present invention, and the blind is lifted;

FIG. 7 is an exploded view to show the power supply of the motorized window blind of the present invention, and

FIG. 8 shows that the power supply is electrically connected to the motor.

### DETAILED DESCRIPTION OF THE PREFERRED EMBODIMENT

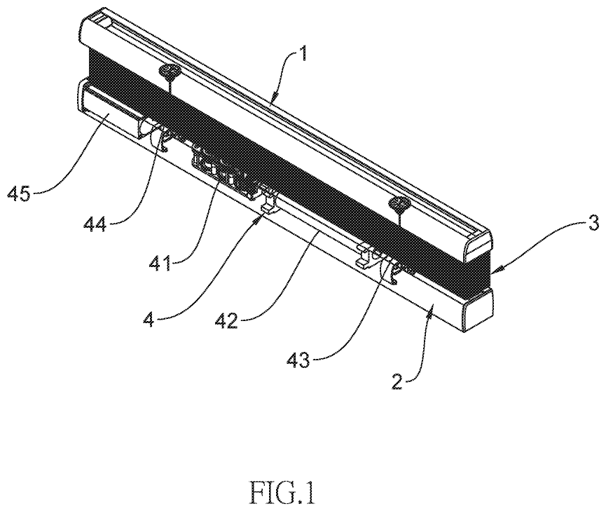

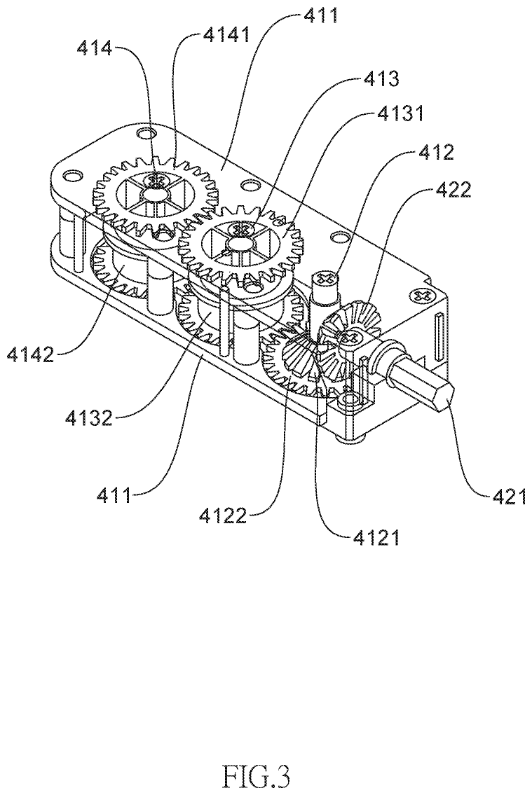

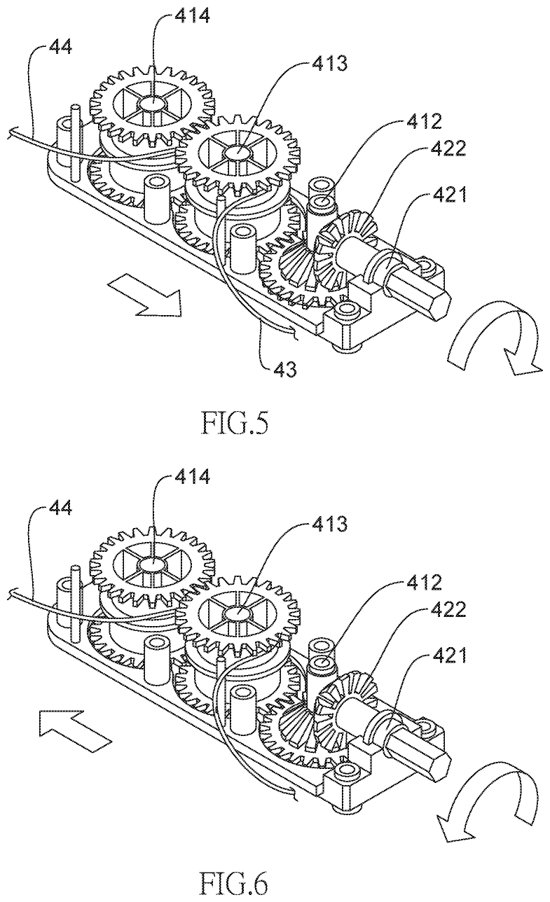

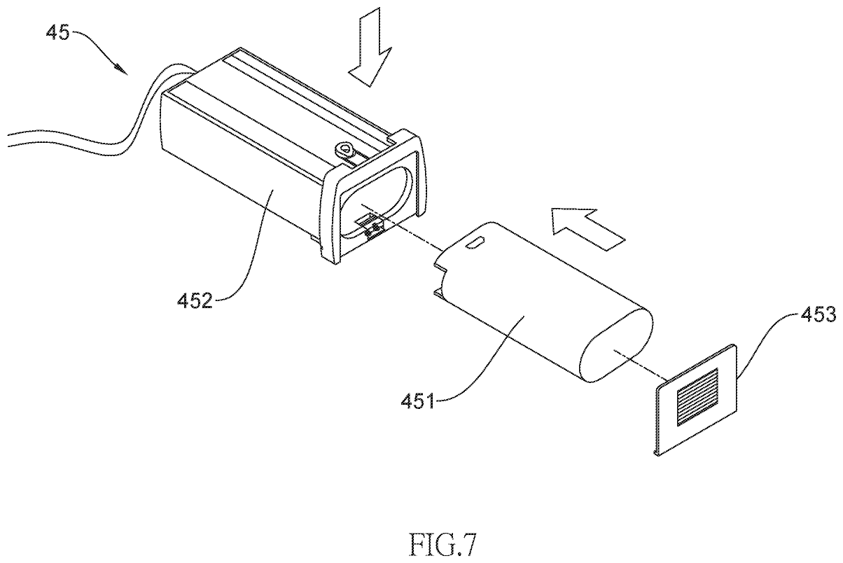

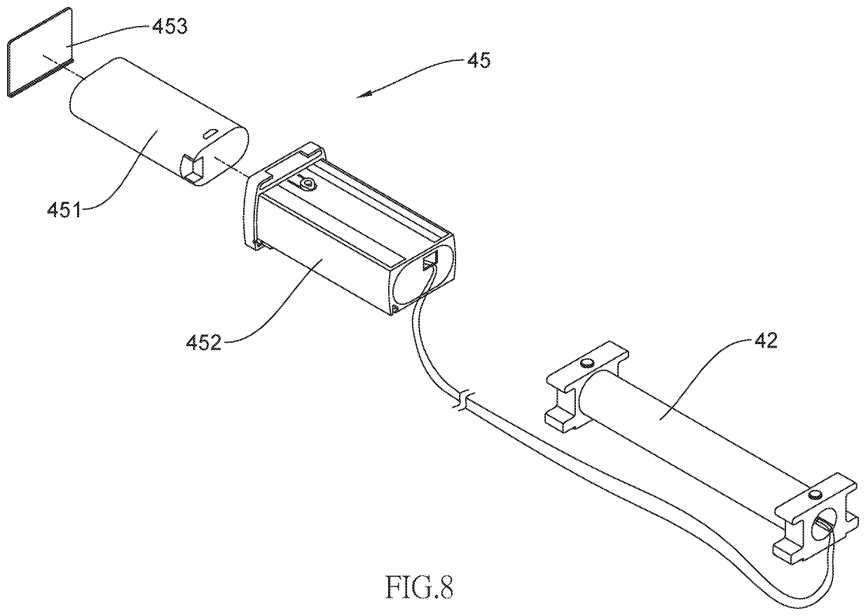

Referring to FIGS. 1 to 8, the motorized window blind of the present invention comprises a top rail 1, a bottom rail 2, a plurality of slats 3 assembled between the top rail 1 and the bottom rail 2, and a driving device 4 received in the bottom rail 2. The slats 3 are controlled by the driving device 4 to lift or lower the blind. The slats 3 can also be different types and shapes.

The top rail 1 can be a U-shaped rail which is installed to top of a window, and can be easily installed because no driving device 4 received therein.

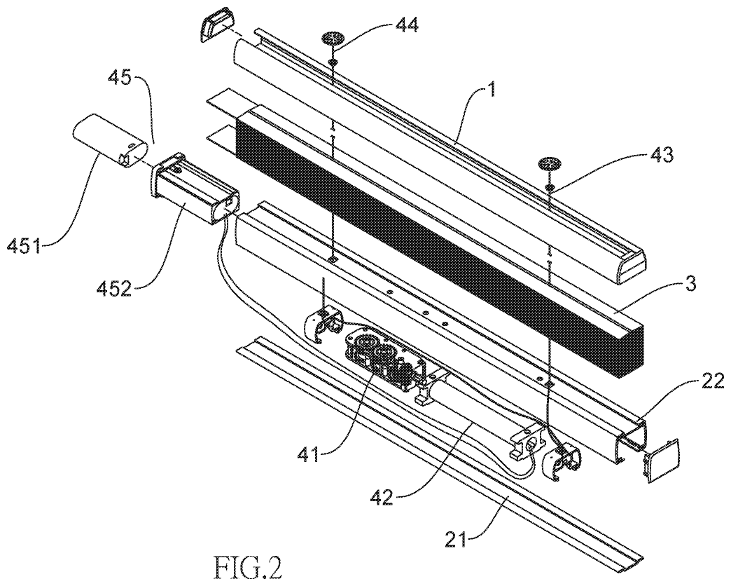

As shown in FIGS. 2, 7 and 8, the bottom rail 2 includes a housing 22 and a bottom plate 21. The driving device 4 is received in the housing 22 and the bottom plate 21 is connected to the housing 22 to hide the driving device 4.

The driving device 4 received in the bottom rail 2 includes a transmission unit 41, a motor 42, a first cord 43 and a second cord 44. The motor 42 is connected to the transmission unit 41. A first end of each of the first and second cords 43, 44 is connected to the transmission unit 41. A second end of each of the first and second cords 43, 44 extends through the slats 3 and is connected to the top rail 1. The transmission unit 41 is driven by the motor 42 to lift and lower the slats 3. The driving device 4 includes a power supply 45 which is electrically connected to the motor 42. It is noted that the driving device 4 may also be is electronically connected with a wireless controller (not shown). The power supply 45 includes a chargeable battery 451 and a battery box 452 in which the chargeable battery 451 is received. A cap 453 is connected to one end of the battery box 452 to seal the battery box 452. Even the electric power is not available, the slats 3 can also be operated manually.

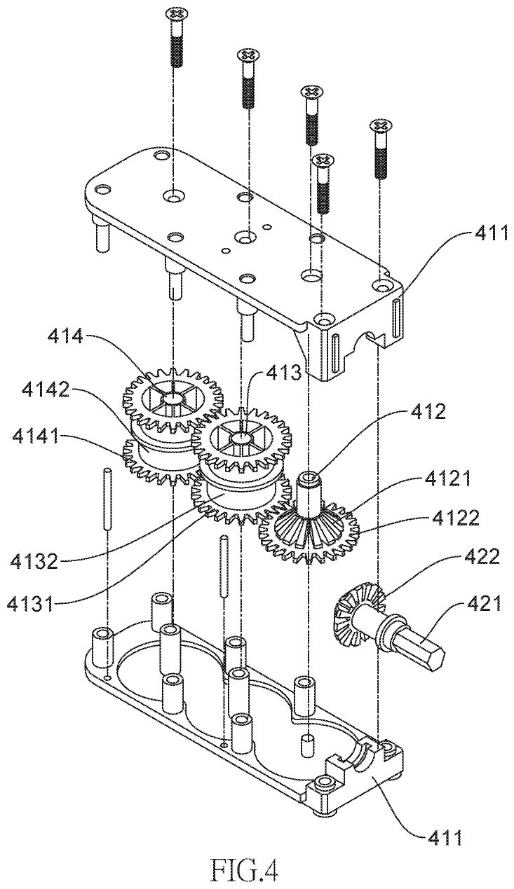

As shown in FIGS. 4 to 6, the transmission unit 41 includes a passive member 412, a first member 413 and a second member 414. The passive member 412, the first member 413 and the second member 414 are received in a box 411. The passive member 412 includes a bevel gear 4121 and a main gear 4122 which is co-axially formed with the bevel gear 4121. The motor 412 includes a shaft 421 which is connected with a driving gear 422. The driving gear 422 is engaged with the bevel gear 4121 so as to drive the passive member 412. The main gear 4122 is located beneath the bevel gear 4121. The first member 413 includes at least one first gear 4131 and a first spool 4132. The second member 414 includes at least one second gear 4141 and a second spool 4142. At least one first gear 4131 of the first member 413 is engaged with the main gear 4122 of the passive member 412 so as to rotate the first member 413 in a rotational direction opposite to a rotational direction of the passive member 412. The first cord 43 is wound to the first spool 4132 and extends through the slats 3 and is connected to the top rail 1. The second gear 4141 of the second member 414 is engaged with the first gear 4131 of the first member 413. The first member 413 rotates the second member 414 to rotate in a rotational direction opposite to a rotational direction of the first member 413. The second cord 44 is wound to the second spool 4142 and extends through the slats 3 and is connected to the top rail 1.

The advantages of the present invention are that the driving device 4 is received in the bottom rail 2 which is located at a position that is easily to be accessed, so that the driving device 4 is easily maintained.

The users can use the wireless controller to operate the driving device 4 to lift or lower the blind.

The top rail 1 does not have the driving device 4 received therein so that it is light and occupies less space and is easily to be installed.

The motorized window blind is able to be operated manually even if the electric power is not available.

While we have shown and described the embodiment in accordance with the present invention, it should be clear to those skilled in the art that further embodiments may be made without departing from the scope of the present invention.

What is claimed is:

1. A motorized window blind comprising:
a top rail;
a bottom rail;
a plurality of slats assembled between the top rail and the bottom rail, and
a driving device received in the bottom rail.

2. The motorized window blind as claimed in claim 1, wherein the driving device is electronically connected with a wireless controller.

3. The motorized window blind as claimed in claim 1, wherein the bottom rail includes a housing and a bottom plate, the driving device is received in the housing and the bottom plate is connected to the housing.

4. A motorized window blind comprising:
a top rail;
a bottom rail;
a plurality of slats assembled between the top rail and the bottom rail, and
a driving device received in the bottom rail and including a transmission unit, a motor, a first cord and a second cord, the motor connected to the transmission unit, a first end of each of the first and second cords connected to the transmission unit, a second end of each of the first and second cords extending through the slats and connected to the top rail, the transmission unit being driven by the motor to lift and lower the slats.

5. The motorized window blind as claimed in claim 4, wherein the driving device includes a power supply which is electrically connected to the motor.

6. The motorized window blind as claimed in claim 5, wherein the power supply includes a chargeable battery and a battery box in which the chargeable battery is received.

7. The motorized window blind as claimed in claim 4, wherein the driving device is electronically connected with a wireless controller.

8. The motorized window blind as claimed in claim 4, wherein the transmission unit includes a passive member, a first member and a second member, the passive member, the first member and the second member are received in a box, the passive member includes a bevel gear and a main gear which is co-axially formed with the bevel gear, the motor includes a shaft which is connected with a driving gear, the driving gear is engaged with the bevel gear so as to drive the passive member, the main gear is located beneath the bevel gear, the first member includes at least one first gear and a first spool, the second member includes at least one second gear and a second spool, the at least one first gear of the first member is engaged with the main gear of the passive member so as to rotate the first member in a rotational direction opposite to a rotational direction of the passive member, the first cord is wound to the first spool and extends through the slats and is connected to the top rail, the at least one second gear of the second member is engaged with the at least one first gear of the first member, the first member rotates the second member to rotate in a rotational direction opposite to a rotational direction of the first member, the second cord is wound to the second spool and extends through the slats and is connected to the top rail.

9. The motorized window blind as claimed in claim 4, wherein the bottom rail includes a housing and a bottom plate, the driving device is received in the housing and the bottom plate is connected to the housing.
